(19) United States
(12) Patent Application Publication
(10) Pub. No.: US 2025/0364155 A1
(43) Pub. Date: Nov. 27, 2025

(54) INSULATED WIRE, COIL, ROTATING ELECTRICAL MACHINE, AND ELECTRICAL OR ELECTRONIC EQUIPMENT

(71) Applicant: Essex Solutions Japan Co., Ltd., Tokyo (JP)

(72) Inventors: Tomomi TATEBE, Tokyo (JP); Natsuko HARA, Tokyo (JP); Daisuke MUTO, Tokyo (JP)

(73) Assignee: Essex Solutions Japan Co., Ltd., Tokyo (JP)

(21) Appl. No.: 19/242,060

(22) Filed: Jun. 18, 2025

Related U.S. Application Data
(63) Continuation of application No. PCT/JP2023/041076, filed on Nov. 15, 2023.

(30) Foreign Application Priority Data
Dec. 20, 2022 (JP) 2022-203729

(51) Int. Cl. H01B 7/02; H01F 5/06; H02K 3/32

(52) U.S. Cl. CPC H01B 7/0216; H01F 5/06; H02K 3/32

(57) ABSTRACT

An insulated wire including a conductor and an insulating film formed by repeating application and baking of a resin varnish on an outer periphery of the conductor,
wherein the insulating film comprises an inner layer that is configured by one or more insulating layers each having a thickness of less than 5 μm, and an outer layer that is outside the inner layer and configured by a plurality of insulating layers, and
wherein among the insulating layers configuring the outer layer, a thickness of an insulating layer in contact with the inner layer is 5 μm or more, and an average of thicknesses of the respective insulating layers configuring the outer layer is 5 μm or more.

### CROSS-REFERENCE TO RELATED APPLICATIONS

This application is a Continuation of PCT International Application No. PCT/JP2023/041076 filed on Nov. 15, 2023, which claims priority under 35 U.S.C. § 119 (a) to Japanese Patent Application No. 2022-203729 filed in Japan on Dec. 20, 2022. Each of the above applications is hereby expressly incorporated by reference, in its entirety, into the present application.

### FIELD OF THE INVENTION

The present invention relates to an insulated wire, a coil, a rotating electrical machine, and an electrical or electronic equipment.

### BACKGROUND OF THE INVENTION

In coils for an electrical or electronic equipment such as high-speed switching elements, inverter motors, and transformers, an insulated wire including a resin insulating film on an outer peripheral surface of a linear metal conductor is used as a magnet wire. The insulating film of the insulated wire is formed by applying and baking a thermosetting resin or a thermoplastic resin, by extrusion coating a thermoplastic resin, or by combining these.

Such an insulated wire is required to have not only high insulation properties by the insulating film but also characteristics that the insulating film is not cracked or peeled off from the conductor when processing such as bending or elongation is performed. For example, Patent Literature 1 discloses an insulated wire including an adhesive layer that is in direct contact with a conductor and has a content ratio of a total formula amount of imide structures in a polyimide resin skeleton of 27% or more and 33% or less, and an insulating layer made of a polyimide resin having a content ratio of a total formula amount of the imide structures in the polyimide resin skeleton of more than 27% and 37% or less on the adhesive layer, and describes that the obtained insulated wire is excellent in conductor adhesion and interlayer adhesion.

### CITATION LIST

### Patent Literature

Patent Literature 1: JP-A-2017-107701 (“JP-A” means an unexamined published Japanese patent application)

### SUMMARY OF THE INVENTION

### Technical Problem

Winding processing (coil processing) of the insulated wire is becoming more sophisticated year by year, and the insulated wire is subjected to bending processing complicatedly with a small bending radius. Such an insulated wire is required to have conductor adhesion in which an insulating film is hardly peeled off from the conductor even by more advanced bending processing, and high flexibility in which a crack does not occur in the insulating film.

The present invention provides an insulated wire having excellent adhesion between an insulating layer and a conductor and excellent flexibility, and a coil, a rotating electrical machine, and an electrical or electronic equipment using the insulated wire.

### Solution to Problem

As a result of studies to solve the above problem, the present inventors have found that when an insulating film is formed by repeating application and baking of a resin varnish around a conductor, the obtained insulated wire is excellent in adhesion between the insulating film and the conductor and excellent in flexibility by providing one or more insulating layers (I) each having a thickness of less than 5 μm from the conductor side to form an inner layer, forming an insulating layer (II) having a thickness of 5 μm or more in contact with the inner layer, forming a plurality of insulating layers (III) on an outer periphery of the insulating layer (II), and at that time, setting an average of thicknesses of the insulating layers in an outer layer configured by the insulating layer (II) and the insulating layers (III) to 5 μm or more. The present invention has been further studied and completed based on these findings.

That is, the above problem of the present invention has been solved by the following means.

[1]

An insulated wire, including:
a conductor; and
an insulating film formed by repeating application and baking of a resin varnish on an outer periphery of the conductor, wherein the insulating film comprises an inner layer that is configured by one or more insulating layers each having a thickness of less than 5 μm, and an outer layer that is outside the inner layer and configured by a plurality of insulating layers, and
wherein among the insulating layers configuring the outer layer, a thickness of an insulating layer in contact with the inner layer is 5 μm or more, and an average of thicknesses of the respective insulating layers configuring the outer layer is 5 μm or more.
   [2]

The insulated wire described in [1], wherein among the insulating layers configuring the inner layer, a maximum thickness and a minimum thickness of an insulating layer in contact with the conductor satisfy [maximum thickness/minimum thickness]≤2.5.

[3]

The insulated wire described in [1] or [2], wherein a thickness of the insulating film is 60 μm or more and 350 μm or less.

[4]

The insulated wire described in any one of [1] to [3], wherein the insulating film contains polyamideimide and/or polyimide.

[5]

A coil, using the insulated wire described in any one of [1] to [4].

[6]

A rotating electrical machine and an electrical or electronic equipment, including the coil described in [5].

In the present invention or the present specification, when simply referring to “insulating layer”, it means a layer formed by applying and baking a resin varnish once. In the present invention, the insulating layer formed by repeating application and baking of the same resin varnish a plurality of times is regarded as a multilayer insulating layer. That is, even when the resin varnishes are the same or different, a layer formed by one application and baking is counted as one insulating layer. In other words, when application and baking are repeated, an insulating film in which the same number of insulating layers as the number of repetitions are laminated is formed. The number of laminated layers can be confirmed with an optical microscope or a microscope after edging a cross section of the insulating layer.

In the present invention, as described above, the insulating film of the insulated wire is formed by repeating the application and baking of the resin varnish as a specific matter, but this merely indicates a state of the insulating film (that is, it is indicated that the insulating film is an enamel layer), and the structure or characteristics of the insulating film are thereby clarified.

In the present invention or the present specification, a shape of the insulated wire including the conductor and the insulating film in a cross-sectional shape orthogonal to a longitudinal direction of the insulated wire may be simply referred to as a cross-sectional shape. The cross-sectional shape in the present invention does not mean that only a cut surface has a specific shape, but the cross-sectional shape is continuously connected in the longitudinal direction of an entire insulated wire, and the cross-sectional shape orthogonal to this direction is substantially the same for any portion in the longitudinal direction of the insulated wire unless otherwise specified.

In the present invention or the present specification, a numerical value range indicated by using the term “to” means a range including the numerical values described before and after the term “to” as the lower limit value and the upper limit value, respectively.

In the present invention or the present specification, “ppm” described as a unit of concentration is on a mass basis.

### Advantageous Effects of Invention

The insulated wire of the present invention has high adhesion between the insulating layer and the conductor and excellent flexibility. In addition, according to the present invention, a coil, a rotating electrical machine, and an electrical or electronic equipment using the insulated wire having such excellent performance are provided.

### BRIEF DESCRIPTION OF DRAWINGS

FIG. 1 is a schematic sectional view showing one embodiment of an insulated wire of the present invention.

FIG. 2 is a schematic sectional view showing a method of measuring a thickness of an insulating layer of the insulated wire of the present invention.

FIG. 3 is a schematic sectional view showing a method of measuring a maximum thickness and a minimum thickness in an inner innermost layer of the insulated wire of the present invention.

FIG. 4 is a schematic exploded perspective view showing a preferred aspect of a stator used in an electrical or electronic equipment of the present invention.

FIG. 5 is a schematic perspective view showing the preferred aspect of the stator used in the electrical or electronic equipment of the present invention.

### DESCRIPTION OF EMBODIMENTS

A preferred embodiment of the present invention will be described, but the present invention is not limited to the following embodiment except for what is defined in the present invention.

### [Insulated Wire]

An insulated wire of the present invention includes a conductor and an insulating film covering an outer periphery of the conductor. This insulating film is a so-called enamel layer (multilayer enamel layer) formed by repeating application and baking of a resin varnish. The resin used for respective insulating layers configuring the insulating film may be a thermosetting resin or a thermoplastic resin, and is ordinarily a thermosetting resin. The insulating layer is classified into an inner layer and an outer layer according to a thickness of the insulating layer, and the inner layer and the outer layer are collectively referred to as an insulating film in the present invention.

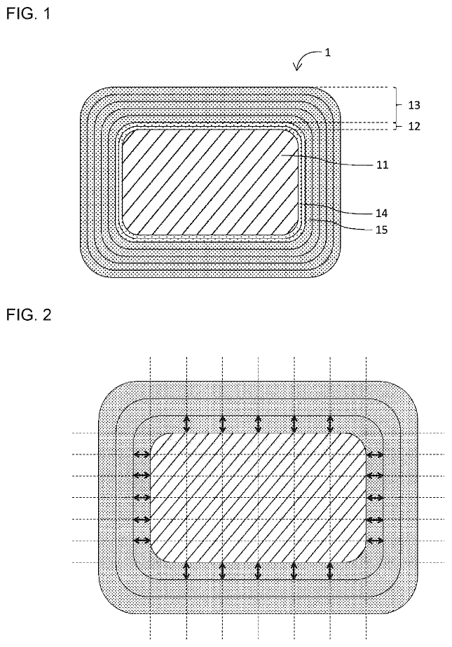

FIG. 1 shows a cross-sectional view of one embodiment of the insulated wire of the present invention. An insulated wire 1 includes a conductor 11, an inner layer 12 formed on an outer peripheral surface of the conductor 11, and an outer layer 13 formed on an outer peripheral surface of the inner layer 12. In the insulated wire shown in FIG. 1, each of the inner layer 12 and the outer layer 13 is a laminated insulating layer (multilayer insulating layer) in which a plurality of insulating layers are laminated.

In the inner layer 12, an insulating layer disposed on the outer peripheral surface of the conductor in contact with the conductor is an inner innermost layer 14. In the outer layer 13, an insulating layer that is in contact with an outermost insulating layer (inner outermost layer) of the inner layer and disposed on an outer peripheral surface of the inner outermost layer is an outer innermost layer 15.

A cross-sectional shape of the insulated wire of the present invention is preferably similar to that of the conductor, and particularly preferably, a shape of the entire insulating film, that is, a cross-sectional shape of the insulating film on an outermost surface on a side opposite to the conductor is similar to that of the conductor. The similar shape is not limited to a perfect similar shape, and may be a substantially similar shape.

### <Conductor>

As the conductor used in the present invention, a conductor conventionally used in the insulated wire can be used, and examples thereof include a metal conductor such as a copper wire and an aluminum wire. In the present invention, a copper conductor is preferable, and among them, copper to be used is preferably low oxygen copper having an oxygen content of 30 ppm or less, and more preferably low oxygen copper or oxygen-free copper having an oxygen content of 20 ppm or less. When the oxygen content is 30 ppm or less, in a case where the conductor is melted by heat for welding, voids due to contained oxygen are not generated in the welded portion, and it is possible to prevent the electrical resistance of the welded portion from deteriorating and to maintain the strength of the welded portion.

When the conductor is aluminum, various aluminum alloys can be used depending on the application in consideration of the required mechanical strength. For applications such as a rotating electrical machine, pure aluminum having a purity of 99.00% or more capable of obtaining a high current value is preferable.

The cross-sectional shape orthogonal to a longitudinal direction of the conductor used in the present invention is not particularly limited. For example, a conductor having a circular or rectangular (flat angular shape) cross-sectional shape can be exemplified. In the present invention, a conductor having a rectangular cross-sectional shape, that is, a flat angular conductor is preferable. A conductor having a rectangular cross-sectional shape has a higher space factor with respect to a slot of a stator core during winding than a conductor having a circular cross-sectional shape. Therefore, it is preferable for applications in which many insulated wires are incorporated in a certain narrow space. As a preferable example of the conductor used in the present invention, FIG. 1 shows a case where the conductor has a rectangular cross section (flat angular shape).

The conductor having a rectangular cross-sectional shape preferably has a shape in which chamfers (curvature radius r) are provided at four corners as shown in FIG. 1 in terms of suppressing partial discharge from corner portions (corner portions). The curvature radius r is preferably 0.6 mm or less, and more preferably in a range from 0.2 to 0.4 mm.

A size of the conductor is not particularly limited, but in a case of a flat angular conductor in the rectangular cross-sectional shape, a width (long side) thereof is preferably 1.0 to 10.0 mm, more preferably 1.0 to 5.0 mm, still more preferably 1.4 to 4.0 mm, and a thickness (short side) is preferably 0.4 to 3.0 mm, and more preferably 0.5 to 2.5 mm. A ratio of the length (thickness: width) between the width (long side) and the thickness (short side) is preferably 1:1 to 1:20, and more preferably 1:1 to 1:4. Meanwhile, in a case of the conductor having a circular cross-sectional shape, a diameter thereof is preferably 0.3 to 3.0 mm, and preferably 0.4 to 2.7 mm.

### <Insulating Film>

A thickness of the insulating film is preferably 60 μm or more and 350 μm or less, more preferably 80 μm or more and 300 μm or less, still more preferably 90 μm or more and 250 μm or less, and still more preferably 100 μm or more and 200 μm or less from the viewpoint of applying a higher partial discharge inception voltage to the insulated wire of the present invention.

In addition, a number of repetitions of application and baking for forming the insulating film is preferably 35 times or less, more preferably 10 times or more and 35 times or less, still more preferably 12 times or more and 30 times or less, and still more preferably 15 times or more and 25 times or less. In the present invention, “the number of repetitions of application and baking” is synonymous with “the number of insulating layers configuring the insulating film”. That is, the number of insulating layers configuring the insulating film is preferably 35 or less, more preferably 10 or more and 35 or less, still more preferably 12 or more and 30 or less, and still more preferably 15 or more and 25 or less.

The insulating film in the insulated wire of the present invention is classified into an inner layer and an outer layer based on the thickness of each insulating layer.

In the present invention, the “inner layer” means, among the inner innermost layer and the insulating layers formed (laminated) from the inner innermost layer toward an outside (opposite side to the conductor), a region of the insulating layers each having a thickness of continuously less than 5 μm. That is, the thicknesses of the respective insulating layers configuring the inner layer are less than 5 μm. When the inner layer is a single layer in the present invention, the inner layer itself is the inner innermost layer.

In addition, in the present invention, the “outer layer” means a region in which the innermost (conductor side) insulating layer among the insulating layers having a thickness of 5 μm or more is set as the outer innermost layer, and which is formed by the outer innermost layer and the insulating layers formed from the outer innermost layer toward an outside (opposite side to the conductor). The outer layer may include an insulating layer having a thickness of less than 5 μm, but an average of thicknesses of the respective insulating layers configuring the outer layer is 5 μm or more.

The thickness of each insulating layer can be measured, for example, by the method described in Examples. Specifically, when the conductor of the insulated wire is a flat angular conductor, as shown in FIG. 2, in cross-sectional observation of the insulated wire, thicknesses at a total of 20 points, that is, five points at equal intervals are measured for each of two long sides and two short sides corresponding to a plane of the insulating layer to be measured, and an average value of the thicknesses at the total of 20 points is defined as the thickness of the insulating layer. The “plane of the insulating layer” means a plane immediately above a surface other than the chamfered portions of the conductor. When the cross-sectional shape of the conductor of the insulated wire is circular, thicknesses at a total of eight points at equal intervals are measured for the insulating layer to be measured in the cross-sectional observation of the insulated wire, and an average value of the thicknesses of the total of eight points is defined as the thickness of the insulating layer.

The thickness at each measurement point is a shortest distance between an inner boundary surface and an outer boundary surface of each insulating layer.

### <Inner Layer>

The respective insulating layers configuring the inner layer may be layers of the same material or layers of different materials. The layers are preferably layers of the same material.

The inner layer is formed by an application and baking step of applying and baking a resin varnish. In the present invention, even when the same resin varnish is repeatedly applied and baked, a layer formed by one application and baking is counted as one layer. Therefore, the inner layer is a layer in which one or more insulating layers are laminated. The number of repetitions of application and baking for forming the inner layer is preferably one time or more and six times or less, more preferably two times or more and five times or less, and still more preferably two times or three times from the viewpoint of further improving the conductor adhesion and the flexibility. That is, the number of insulating layers configuring the inner layer is preferably one or more and six or less, more preferably two or more and five or less, and still more preferably two or three.

In the insulated wire of the present invention, an average of thicknesses of the respective insulating layers configuring the inner layer is preferably 1 μm or more and less than 5 μm, more preferably 2 μm or more and 4.5 μm or less, and still more preferably 2 μm or more and 4 μm or less from the viewpoint of further improving the conductor adhesion, the viewpoint of preventing conductor oxidation, and the viewpoint of suppressing generation of lumps. The average of thicknesses of the respective insulating layers configuring the inner layer is an arithmetic average of thicknesses of the respective insulating layers obtained by measuring the thicknesses of the respective insulating layers as described above. That is, it is calculated by measuring the thicknesses of the respective insulating layers as described above and dividing a total value of the thicknesses of the respective insulating layers configuring the inner layer by the number of insulating layers configuring the inner layer.

In addition, the thickness of each of the insulating layers configuring the inner layer is preferably within a range of ±50% of the average of thicknesses of the respective insulating layers configuring the inner layer, and more preferably within a range of ±25% of the average of thicknesses of the respective insulating layers configuring the inner layer. That is, it is preferable to satisfy [average of thicknesses of respective insulating layers configuring inner layer×0.5]≤thickness of each of insulating layers configuring inner layer≤[average of thicknesses of respective insulating layers configuring inner layer×1.5], and it is more preferable to satisfy [average of thicknesses of respective insulating layers configuring inner layer×0.75]≤thickness of each of insulating layers configuring inner layer≤[average of thicknesses of respective insulating layers configuring inner layer×1.25].

### (Resin Varnish)

The resin varnish contains an organic solvent (organic solvent) or the like in order to varnish the resin. Examples of the organic solvent include: amide-series solvents such as N,N-dimethylacetamide (DMAc), N-methyl-2 pyrrolidone (NMP), and N,N-dimethylformamide (DMF); urea-series solvents such as N,N-dimethylethyleneurea, N,N-dimethylpropyleneurea, and tetramethylurea; lactone-series solvents such as y-butyrolactone and y-caprolactone; carbonate-series solvents such as propylene carbonate; ketone-series solvents such as methyl ethyl ketone, methyl isobutyl ketone, and cyclohexanone; ester-series solvents such as ethyl acetate, n-butyl acetate, butyl cellosolve acetate, butyl carbitol acetate, ethyl cellosolve acetate, and ethyl carbitol acetate; glyme-series solvents such as diglyme, triglyme, and tetraglyme; hydrocarbon-series solvents such as toluene, xylene, and cyclohexane; phenol-series solvents such as cresol, phenol, and halogenated phenol; sulfone-series solvents such as sulfolane; and dimethyl sulfoxide (DMSO).

Among them, DMAc, NMP, DMF, N,N-dimethylethyleneurea, N,N-dimethylpropyleneurea, tetramethylurea, and DMSO are more preferable, and DMAc and NMP are still more preferable from the viewpoint of not having a hydrogen atom that is likely to inhibit the crosslinking reaction by heating. The organic solvent and the like may be used singly or in combination of two or more types thereof.

The resin varnish may contain various types of additives such as an adhesion aid, a foaming nucleating agent, an antioxidant, an antistatic agent, an ultraviolet inhibitor, a light stabilizer, a fluorescent brightener, a pigment, a dye, a compatibilizer, a lubricant, a reinforcing agent, a flame retardant, a crosslinking agent, a crosslinking aid, a plasticizer, a thickener, a viscosity-decreasing agent, and an elastomer as long as the characteristics are not impaired.

The resin varnish may contain inorganic fine particles as long as the characteristics are not impaired. Examples of such inorganic fine particles include zinc oxide, titanium oxide, silica, alumina, tin oxide, silicon carbide, strontium titanate, and the like.

### Resin

The resin configuring each insulating layer of the inner layer is not particularly limited, and examples thereof include thermosetting resins having an imide bond such as polyimide (PI), polyamideimide (PAI), and polyesterimide (PEsI), polyurethane (PU), thermosetting polyester (PEst), H-type polyester (HPE), polyimide hydantoin-modified polyester, polyhydantoin, polybenzimidazole, a melamine resin, and an epoxy resin, and these resins may be used alone or in combination. In addition, an amorphous thermoplastic resin such as polyetherimide (PEI) may be used. Among them, the resin preferably contains a thermosetting resin having an imide bond, and more preferably contains polyimide (PI), polyamideimide (PAI), or a mixed resin thereof. The resin is preferably a thermosetting resin having an imide bond, and more preferably polyimide (PI), polyamideimide (PAI), or a mixed resin thereof.

The kind of the polyimide (PI) is not particularly limited, and an ordinary polyimide such as a wholly aromatic polyimide or a thermosetting aromatic polyimide can be used. In addition, a polyamic acid solution obtained by reacting an aromatic tetracarboxylic dianhydride and an aromatic diamine compound in a polar solvent by a conventional method is used, and a polyamic acid solution obtained by imidization by heat treatment at the time of baking can be used.

Examples of the commercially available polyimide (PI) include trade name: U-imide manufactured by Unitika Corporation, trade name: U-varnish manufactured by Ube Industries, Ltd., and trade name: #3000 manufactured by DU PONT-TORAY CO., LTD.

The polyamideimide (PAI) has a lower thermal conductivity and a higher dielectric breakdown voltage than other resins, and can be baked and cured. The kind of polyamideimide that can be used in the present invention is not particularly limited, and examples thereof include a polyamideimide obtained by directly reacting a tricarboxylic acid anhydride with a diisocyanate compound in a polar solvent, and a polyamideimide obtained by first reacting a diamine compound with a tricarboxylic acid anhydride in a polar solvent, introducing an imide bond first, and then amidation with a diisocyanate compound. Examples of the commercially available polyamideimide (PAI) include trade name: HI406 manufactured by Hitachi Chemical Co., Ltd.

When the inner layer is a laminated insulating layer in which a plurality of insulating layers are laminated, the thickness of the inner innermost layer is preferably thinner than the average of thicknesses of the respective insulating layers configuring the inner layer.

From the viewpoint of improving the conductor adhesion and the flexibility, a relationship between a maximum thickness and a minimum thickness of the inner innermost layer preferably satisfies [maximum thickness/minimum thickness]≤2.5, more preferably satisfies [maximum thickness/minimum thickness]≤2.3, and still more preferably satisfies [maximum thickness/minimum thickness]≤2.1.

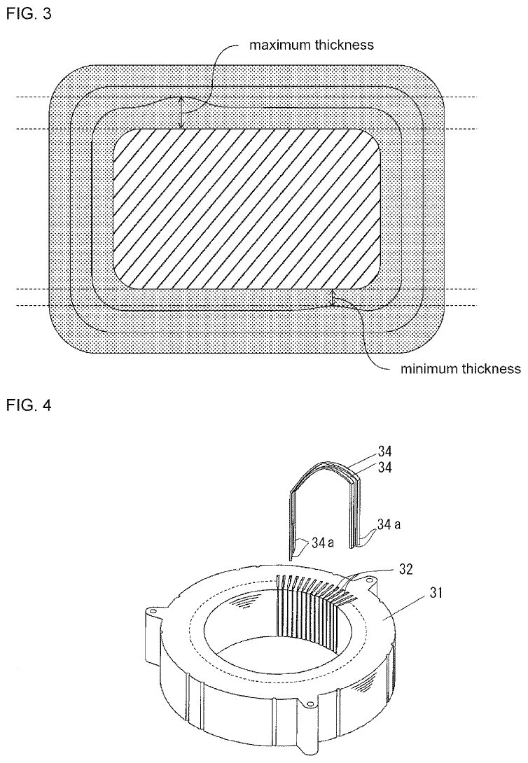

The maximum thickness of the inner innermost layer and the minimum thickness of the inner innermost layer can be measured, for example, by the method described in Examples. Specifically, for the flat angular insulated wire shown in FIG. 3, in the cross-sectional observation of the insulated wire, a thickness of the inner innermost layer in a vertical direction is measured from the two long sides and the two short sides corresponding to the planar portion of the outer periphery of the conductor, a maximum value of the obtained thickness is defined as a “maximum thickness”, and a minimum value of the obtained thickness is defined as a “minimum thickness”. In determining the minimum thickness and the maximum thickness, the thicknesses of the chamfered portions at the four corners of the conductor are not considered.

When the cross-sectional shape of the conductor of the insulated wire is circular, a thickness in the vertical direction is measured from a tangent line of a surface of the conductor in the cross-sectional observation of the insulated wire, and a maximum value of the obtained thickness is defined as a “maximum thickness” and a minimum value of the obtained thickness is defined as a “minimum thickness”.

### <Outer Layer>

Respective insulating layers configuring the outer layer may be layers of the same material or layers of different materials, and are preferably layers of the same material.

The outer layer is also formed by an application and baking step of applying and baking a resin varnish in the same manner as the inner layer. A number of repetitions of application and baking for forming the outer layer is preferably nine times or more and 30 times or less, more preferably ten times or more and 25 times or less, and still more preferably 13 times or more and 22 times or less, from the viewpoint of achieving appropriate baking conditions and maintaining the adhesion strength with the conductor and the mechanical characteristics. That is, the number of insulating layers configuring the outer layer is preferably nine or more and 30 or less, more preferably ten or more and 25 or less, and still more preferably 13 or more and 22 or less.

The thicknesses of the respective insulating layers configuring the outer layer are preferably 4 μm or more, more preferably 4.5 μm or more, and still more preferably 5 μm or more from the viewpoint of improving flexibility and suppressing generation of lumps due to volatilization of the solvent. The thickness is preferably 15 μm or less, and more preferably 10 μm or less.

An average of thicknesses of the respective insulating layers configuring the outer layer is 5 μm or more, and from the viewpoint of improving flexibility and suppressing generation of lumps, it is preferably 5 μm or more and 15 μm or less, and more preferably 5 μm or more and 10 μm or less. The average of thicknesses of the respective insulating layers configuring the outer layer is calculated by measuring the thicknesses of the respective insulating layers as described above (measuring in the same manner as in the measurement of the thicknesses of the respective insulating layers configuring the inner layer), and dividing the total value of the thicknesses of the respective insulating layers configuring the outer layer by the number of insulating layers configuring the outer layer.

In addition, a thickness of each of the insulating layers configuring the outer layer is preferably within a range of ±50% of the average of thicknesses of the respective insulating layers configuring the outer layer, and preferably within a range of ±25% of the average of thicknesses of the respective insulating layers configuring the outer layer. That is, it is preferable to satisfy [average of thicknesses of respective insulating layers configuring outer layer×0.5]≤thickness of each of insulating layers configuring outer layer≤[average of thicknesses of respective insulating layers configuring outer layer×1.5], and it is more preferable to satisfy [average of thicknesses of respective insulating layers configuring outer layer×0.75] ≤ thickness of each of insulating layers configuring outer layer≤[average of thicknesses of respective insulating layers configuring outer layer×1.25].

As a kind of a resin configuring the outer layer, the resin described as the resin configuring the inner layer can be preferably used. In addition, a resin of the same material as the resin configuring the inner layer may be used, or a resin of a different material may be used. In particular, the outer layer preferably contains polyimide (PI), polyamideimide (PAI), or a mixed resin thereof, and more preferably is formed of polyimide (PI), polyamideimide (PAI), or a mixed resin thereof. In addition, as the kind of the organic solvent for varnishing the resin, those described as the organic solvent used for the resin of the inner layer can be preferably used.

The insulated wire of the present invention may further include a reinforcing insulating layer on the outer periphery of the outer layer. By providing the reinforcing insulating layer, ATF resistance and the like of the insulated wire of the present invention can be further enhanced. The reinforcing insulating layer is preferably an extrusion coating layer composed of a thermoplastic resin layer. As the thermoplastic resin configuring the thermoplastic resin layer, a thermoplastic resin generally used for the insulating film can be applied.

### [Method of Producing Insulated Wire]

The insulated wire of the present invention can be obtained by forming insulating layers by the application and baking step in which an operation of applying and baking the same or different resin varnish to the outer periphery of the conductor is repeated a plurality of times.

A method of applying the resin varnish onto the conductor may be a conventional method, and for example, a method of using a varnish application die having a similar shape to that of the conductor, or in a case where the cross-sectional shape of the conductor is rectangular, a die called a “universal die” formed in a parallel cross beam shape can be used.

As described above, a commercially available product may be used as the resin varnish, and in this case, since the resin varnish is dissolved in an organic solvent, the resin varnish contains an organic solvent.

The conductor applied with the resin varnish is baked in a baking furnace by a conventional method. Specific baking conditions depend on the shape of the furnace used and the like, but can be achieved by setting the passing time to 10 to 90 seconds at a furnace temperature of 400° C. to 650° C. in the case of a natural convection type vertical furnace of about 8 m. The application amount of the resin varnish can be appropriately set so as to have the intended thickness of each insulating layer.

### [Coil, Rotating Electrical Machine, and Electrical or Electronic Equipment]

The insulated wire of the present invention can be used as a coil in a field requiring electric characteristics (withstand voltage) and heat resistance, such as a rotating electrical machine and various types of electrical or electronic equipment. For example, the insulated wire of the present invention is used for a motor, a transformer, and the like, and can constitute a high-performance rotating electrical machine and an electrical or electronic equipment. In particular, it is suitably used as a winding wire for a driving motor of a hybrid vehicle (HV) or an electric vehicle (EV).

Examples of the coil of the present invention include a coil formed by subjecting the insulated wire of the present invention to coil processing, and a coil formed by subjecting the insulated wire of the present invention to bending processing and then electrically coupling predetermined parts. The coil formed by subjecting the insulated wire of the present invention to coil processing is not particularly limited, and examples thereof include a coil formed by winding a long insulated wire in a spiral. In such a coil, the number of turns of the insulated wire or the like is not particularly limited. Ordinarily, an iron core or the like is used to wind the insulated wire in a spiral.

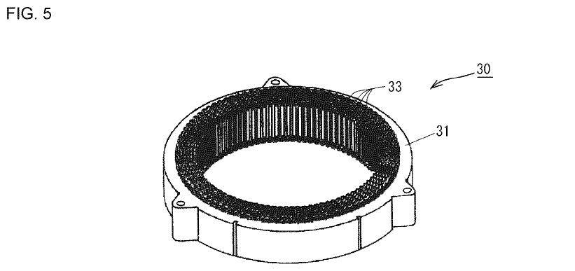

Examples of the coil formed such that, after the insulated wire of the present invention is subjected to bending processing, predetermined parts thereof are electrically coupled, include a coil used for a stator of a rotating electrical machine or the like. Coils 33 (see FIGS. 4 and 5) are the example of such coil. The coils 33 are formed by cutting the insulated wire of the present invention in a predetermined length, subjecting the cut pieces to bending processing in a U shape or the like to prepare a plurality of wire segments 34, and alternately coupling two open ends (terminals) 34a of the U shape or the like of each wire segment 34, as shown in FIG. 4.

The electrical or electronic equipment using the coil thus produced is not particularly limited. One preferred aspect of such electrical or electronic equipment is a transformer. In addition, examples of the preferred aspect thereof include a rotating electrical machine (particularly, driving motors of HV and EV) including a stator 30 shown in FIGS. 4 and 5. Such a rotating electrical machine can be configured similar to a conventional rotating electrical machine except for being provided with the stator 30.

The stator 30 has a configuration similar to a configuration of a conventional stator except that the wire segments 34 are formed using the insulated wire of the present invention. Specifically, the stator 30 has a stator core 31, and the coils 33 in which, as shown in FIG. 4, the wire segments 34 composed of the insulated wire of the present invention are incorporated in slots 32 of the stator core 31 and the open ends 34a are electrically coupled. The coils 33 are fixed such that adjacent fusing layers, or the fusing layer and the slots 32 are bonded. Herein, the wire segments 34 may be incorporated in each slot 32 one by one. However, it is preferable that a pair of wire segments 34 are incorporated in each slot 32 as shown in FIG. 4. In the stator 30, the coils 33, which are formed by alternately coupling the open ends 34a that are two ends of the wire segments 34 which have been subjected to bending processing as described above, are housed in the slots 32 of the stator core 31. At this time, the open ends 34a of the wire segments 34 may be coupled and then housed in the slots 32, or after the wire segments 34 are housed in the slots 32, the open ends 34a of the wire segments 34 may be subjected to bending processing and coupled.

### EXAMPLES

Hereinafter, the present invention will be described in more detail with reference to Examples, but the present invention is not limited to these aspects. In the following Examples, “ppm” is on a mass basis.

### <Producing Method>

### Example 1

An insulated wire having a conductor and an insulating film (inner layer and outer layer) was produced by the following method.

A flat angular conductor having a flat angular cross section (3.5 mm in width×2.0 mm in length, and a curvature radius r of the chamfered portions at each of the four corners=0.3 mm) (copper having an oxygen content of 15 ppm) was used as the conductor.

A polyimide (PI) varnish (trade name: Uimide, solvent: DMAc, manufactured by Unitika Corporation) was applied to the surface of the conductor using a die in which a shape of an outer shape of a cross section of an innermost thermosetting resin layer in contact with the conductor was similar to the cross-sectional shape of the conductor, and passed through a baking furnace having a furnace length of 8 m set at 600° C. at a passing time of 20 seconds, and this application and baking were repeated twice in total to have the thickness described in the following Table 1, thereby forming a thermosetting resin layer (inner layer) composed of two layers.

Subsequently, the PI varnish was applied to the surface of the thermosetting resin layer (inner layer) using a die in which an outer shape of a cross section was similar to the cross-sectional shape of the conductor, passed through a baking furnace having a furnace length of 8 m set at 600° C. at a passing time of 20 seconds, and this application and baking were repeated 20 times in total to have the thickness described in the following Table 1, thereby forming a thermosetting resin layer (outer layer) composed of 20 layers.

In this way, an insulated wire of Example 1 having an inner layer and an outer layer as insulating films was obtained.

The measurement of the thickness of the insulating layer in this Example will be described.

In the cross-sectional observation of the insulated wire, thicknesses of a total of 20 points, that is, five points at equal intervals were measured for each of two long sides and two short sides corresponding to a plane of the insulating layer to be measured with a digital microscope (trade name: VHX-7000, manufactured by Keyence Corporation). An average value of the measured values was taken as a thickness of each insulating layer.

A total thickness (μm) of respective insulating layers belonging to the inner layer was calculated by summing the thicknesses of the respective insulating layers configuring the inner layer, and a value obtained by dividing the total thickness by the number of inner layers was taken as an “average thickness (μm) of the insulating layers” in the inner layer. In addition, a total thickness (μm) of respective insulating layers belonging to the outer layer was calculated by summing the thicknesses of the respective insulating layers belonging to the outer layer, and a value obtained by dividing the total thickness by the number of outer layers was taken as an “average thickness (μm) of the insulating layers” in the outer layer. The measurement results are as shown in Table 1.

In addition, a maximum thickness and a minimum thickness of the innermost layer of the inner layer were measured, and a “maximum thickness/minimum thickness” of the innermost layer was calculated. The results are also shown in Table 1.

### Examples 2 to 10

Respective insulated wires of Examples 2 to 10 were obtained in the same manner as in Example 1 above except that the thicknesses of the insulating layers configuring the inner layer and the outer layer were set to the thicknesses described in the following Table 1.

### Example 11

An insulated wire of Example 11 was obtained in the same manner as Example 1 above except that a polyamideimide (PAI) varnish (trade name: HI406, solvent: DMAc, manufactured by Hitachi Chemical Co., Ltd.) was used as the resin, and the thickness of the insulating layer was set to the thickness described in the following Table 1 by applying and baking the varnish.

### Comparative Example 1

An insulated wire of Comparative Example 1 was obtained in the same manner as Example 1 above except that the inner layer was not formed and the thicknesses of the insulating layers configuring the outer layer were set to the thicknesses described in the following Table 1.

### Comparative Example 2

An insulated wire of Comparative Example 2 was obtained in the same manner as Example 1 above except that the outer layer was not formed and the thicknesses of the insulating layers configuring the inner layer were set to the thicknesses described in the following Table 1.

In the insulated wires of Examples 1 to 11 and Comparative Example 2, the thicknesses of the insulating layers configuring the inner layer were all less than 5 μm (1 to 4.5 μm). Also, for the insulated wires of Examples 1 to 11 and Comparative Example 1, the thickness of the outer innermost layer (for the insulated wires of Examples 1 to 11, an adhesive layer with the inner layer in the outer layer, and for the insulated wire of Comparative Example 1, an adhesive layer with the conductor in the outer layer) was 5 μm or more (5 to 15 μm).

In addition, the thicknesses of the respective insulating layers configuring the inner layer were within a range of ±50% of the average thickness of the respective insulating layers configuring the inner layer, and the thicknesses of the respective insulating layers configuring the outer layer were within a range of ±25% of the average thickness of the respective insulating layers configuring the outer layer.

The conductor adhesion strength and flexibility of each of the insulated wires produced above were evaluated as follows. The results obtained are shown collectively in the following Table 1.

### [Conductor Adhesion Strength]

The adhesion strength between the conductor and the inner layer (inner innermost layer) (in the insulated wire of Comparative Example 1, the adhesion strength between the conductor and the outer layer (outer innermost layer)) was measured by performing a 180 degree peel test (JIS method) between the conductor and the insulating layer based on Japanese Industrial Standard: JIS Z 0237.

For each of the insulated wires produced in Examples and Comparative Examples, a jig having a cutter connected to a micrometer was used, and a cut of 50 mm or more with a width of 1 mm was made in the longitudinal direction. Note that this cut was made to reach the conductor. The insulating film was peeled off from the end of the cut insulated wire, and the 180° peeling test was performed in the longitudinal direction along the cut at a speed of 4 mm/min using a tensile tester (manufactured by Shimadzu Corporation, apparatus name “Autograph AGS-X”). An average value (average value of unevenness) of the peel strength of a length of 50 mm was defined as the adhesion strength, and the conductor adhesion strength was evaluated based on the following evaluation criteria.

### Evaluation Criteria

A+: 1.2 N/mm or more
A: 0.8 N/mm or more and less than 1.2 N/mm
B: 0.5 N/mm or more and less than 0.8 N/mm
C: less than 0.5 N/mm

### [Flexibility]

For each of the insulated wires produced in Examples and Comparative Examples, a linear test piece having a length of 300 mm was cut out and elongated to 15% in the longitudinal direction, and then the linear test piece was bent at 180° (U-shape) in an edge (short side) plane direction of the conductor with an iron core having a diameter of 4.0 mm as an axis. The presence or absence of cracks in the film at the apex of the bent portion was examined. When no crack was observed, the insulated wire was elongated to 20% and evaluated in the same manner. When no crack was observed even at 20%, the insulated wire was elongated to 25% and evaluated in the same manner. The results were evaluated for flexibility based on the following evaluation criteria. The term “15% elongation” means that the length of the linear test piece was elongated to 1.15 times the length before the test.

### Evaluation Criteria

A+: No cracking occurs at 25% elongation.
A: Cracking does not occur at 20% elongation, but cracking occurs at 25% elongation.
B: Cracking does not occur at 15% elongation, but cracking occurs at 20% elongation.
C: Cracking occurs at 15% elongation.

TABLE 1

| | | Ex. | Ex. | Ex. | Ex. | Ex. | Ex. | Ex. | Ex. | Ex. | Ex. | Ex. | CEx. | CEx. |
|---|---|---|---|---|---|---|---|---|---|---|---|---|---|---|
| | | 1 | 2 | 3 | 4 | 5 | 6 | 7 | 8 | 9 | 10 | 11 | 1 | 2 |
| Insulating | Inner layer | | | | | | | | | | | | | |
| film | Type of resin | PI | PI | PI | PI | PI | PI | PI | PI | PI | PI | PAI | — | PI |
| | Number of | 2 | 2 | 2 | 2 | 2 | 1 | 6 | 3 | 2 | 2 | 2 | — | 26 |
| | insulating | | | | | | | | | | | | | |
| | layers | | | | | | | | | | | | | |
| | Average | 1 | 2 | 2 | 4 | 4.5 | 2 | 2 | 2 | 2 | 2 | 2 | — | 4 |
| | thickness of | | | | | | | | | | | | | |
| | insulating | | | | | | | | | | | | | |
| | layers (μm) | | | | | | | | | | | | | |
| | Total thickness | 2 | 4 | 4 | 8 | 9 | 2 | 12 | 6 | 4 | 4 | 4 | — | 104 |
| | of insulating | | | | | | | | | | | | | |
| | layers (μm) | | | | | | | | | | | | | |
| | Maximum | 2.2 | 2.6 | 1.8 | 1.9 | 2.3 | 1.9 | 2.1 | 2.1 | 1.8 | 1.8 | 1.8 | — | 2.1 |
| | thickness/minimum | | | | | | | | | | | | | |
| | thickness | | | | | | | | | | | | | |
| | of innermost | | | | | | | | | | | | | |
| | layer | | | | | | | | | | | | | |
| | Outer layer | | | | | | | | | | | | | |
| | Type of resin | PI | PI | PI | PI | PI | PI | PI | PI | PI | PI | PAI | PI | — |
| | Number of | 20 | 18 | 20 | 20 | 18 | 20 | 18 | 17 | 10 | 20 | 20 | 22 | — |
| | insulating | | | | | | | | | | | | | |
| | layers | | | | | | | | | | | | | |
| | Average | 5 | 5 | 5 | 5 | 5 | 5 | 5 | 5 | 10 | 15 | 5 | 5 | — |
| | thickness of | | | | | | | | | | | | | |
| | insulating | | | | | | | | | | | | | |
| | layers (μm) | | | | | | | | | | | | | |
| | Total thickness | 100 | 90 | 100 | 100 | 90 | 100 | 90 | 85 | 100 | 300 | 100 | 110 | — |
| | of insulating | | | | | | | | | | | | | |
| | layers (μm) | | | | | | | | | | | | | |
| | Overall | | | | | | | | | | | | | |
| | Thickness (μm) | 102 | 94 | 104 | 108 | 99 | 102 | 102 | 91 | 104 | 304 | 104 | 110 | 104 |

| | | | | | | | | | | | | | |
|---|---|---|---|---|---|---|---|---|---|---|---|---|---|
| Peel strength (conductor | B | B | A+ | A+ | A | B | A | A+ | A+ | A | A+ | C | B |
| adhesion strength) | | | | | | | | | | | | | |
| Bending workability | A | A | A+ | A+ | A | A | B | A+ | A+ | A | A | B | C |
| (flexibility) | | | | | | | | | | | | | |

Since the insulated wire of Comparative Example 1 had no inner layer and the thickness of the insulating layer disposed in contact with the conductor was 5 μm or more, the conductor adhesion of the insulating layer was poor.

This is considered to be because the adhesion strength between the insulating layer and the conductor was reduced due to generation of lumps or the like due to a large thickness of the insulating layer disposed in contact with the conductor. In addition, it was found that since the insulated wire of Comparative Example 2 had no outer layer and the average thickness of the insulating layers configuring the inner layer was 4 μm, the mechanical characteristics of the insulating layers were not improved, and the bending workability was poor.

On the other hand, it was shown that the insulated wires (Examples 1 to 11) satisfying all the requirements of the present invention have excellent conductor adhesion strength and excellent bending workability.

Having described the present invention as related to the embodiment, it is our intention that the present invention not be limited by any of the details of the description, unless otherwise specified, but rather be construed broadly within its spirit and scope as set out in the accompanying claims.

### DESCRIPTION OF SYMBOLS

1 Insulated wire
11 Conductor
12 Inner layer
13 Outer layer
14 Inner innermost layer
15 Outer innermost layer
30 Stator
31 Stator core
32 Slot
33 Coil
34 Wire segment
34a Open end

1. An insulated wire, comprising:
a conductor; and
an insulating film formed by repeating application and baking of a resin varnish on an outer periphery of the conductor, wherein the insulating film comprises an inner layer that is configured by one or more insulating layers each having a thickness of less than 5 μm, and an outer layer that is outside the inner layer and configured by a plurality of insulating layers, and
wherein among the insulating layers configuring the outer layer, a thickness of an insulating layer in contact with the inner layer is 5 μm or more, and an average of thicknesses of the respective insulating layers configuring the outer layer is 5 μm or more.

2. The insulated wire according to claim 1, wherein among the insulating layers configuring the inner layer, a maximum thickness and a minimum thickness of an insulating layer in contact with the conductor satisfy [maximum thickness/minimum thickness]≤2.5.

3. The insulated wire according to claim 1, wherein a thickness of the insulating film is 60 μm or more and 350 μm or less.

4. The insulated wire according to claim 1, wherein the insulating film contains polyamideimide and/or polyimide.

5. A coil, using the insulated wire according to claim 1.

6. A rotating electrical machine and an electrical or electronic equipment, comprising the coil according to claim 5.
